(19) United States
(12) Patent Application Publication
(10) Pub. No.: US 2003/0012854 A1
(43) Pub. Date: Jan. 16, 2003

(54) Lollipop beverage top

(76) Inventor: Jason P. Bacanskas, Ashgrove (AU)

Correspondence Address: GREENBERG & LIEBERMAN, 314 PHILADELPHIA AVE., TAKOMA PARK, MD, 20912, US

(21) Appl. No.: 09/681,979

(22) Filed: Jul. 3, 2001

(51) Int. Cl. A23G 1/00

(52) U.S. Cl. 426/134

(57) ABSTRACT

An attachment for a beverage dispenser which allows the consumer to draw the beverage through the attachment thereby enhancing the flavor. The attachment can be made of a hard candy or other substance which would partially dissolve when exposed to a liquid media. The attachment also includes a handle so that in the event of the beverage being depleted before the candy is consumed, the attachment doubles as a lollipop type consumable.

### BACKGROUND OF INVENTION

The candy industry has been built on better tasting, smelling, and looking novelty candies. The sweeter and more unique the taste of a candy, the better the candy will sell, so say the candy marketers. Moreover, should a candy espouse an attractive scent, the user will be more inclined to devour the candy and purchase another. Even further, a candy which looks different than the average piece of chewing gum or gum drop will tend to generate revenue; the user is intrigued with the concept eating a product which seems to stray from the normal in terms of design.

The candy industry is ever in search of new and upcoming products which might portend or generate a fad. As old products fall by the wayside, new confections continue the candy marketing frenzy. The demand for candy, in part, has been driven by innovations in the candy arena. For example, lollipops are not just lollipops anymore, but they tend to incorporate other candy elements such gum or licorice. When the user licks off enough of the lollipop coating, the center of the lollipop has a special treat. But according to Candy Industry Magazine, some of the newest products extend the notion of the lollipops beyond the normal. Newest lollipops include the Dino Yuckers, Fossil Pops, the Robin Spin Pop, and Bat Signal Candy.

Dino Yuckers are lollipops which fit into a dinosaur-shaped rubber handle. The user feels as if s/he is eating a brightly-colored dinosaur head, claw or tail. Candy Industry Magazine reports that Dino Yuckers come in six variations: three dino heads, two spiked tails and one fierce claw.

Another type of lollipop, the Fossil Pops, are semi-opaque lollipops that resemble quartz rock. The user can view a fossilized skeleton of a dinosaur inside the transparent pop. The handle of the lollipop is actually the dinosaur's tail, which extends past the end of the lollipop. Fossil Pops contain one of three different skeletons, the T-Rex, Stegasaurus and Triceratops.Gotham City crime-stopping super heroes are the focus of the Robin Spin Pop and Bat Signal Candy, two other types of lollipops. The Robin Spin Pop is a lollipop having a molded Robin action figure atop its handle. The lollipop fits securely into the top of the character and spins at the push of a button. Bat Signal Candy is an interactive illuminated lollipop. Bat Signal Candy has a button that illuminates the “bat signal” emblem.

In addition to theme lollipops, lollipop manufacturers have endeavored to push the boundaries of actual taste sensations. In this regard, there have been attempts to incorporate liquids with hard candy lollipops. Several patents are testament to innovative methods of allowing the user to drink as well as lick lollipops.

U.S. Pat. No. 4,229,482, issued to Kreske on Oct. 21, 1980, shows a lollipop with an elongated rigid stick member having an enlarged hollow end portion. The center of the lollipop contains liquid which is inserted under pressure. The lollipop bottom is capped to prevent reverse flow of liquid. Unlike the present invention, Kreske's device does not provide for attachment to a beverage container top. Furthermore, Kreske's device does not provide a means for replacing the lollipop candy itself as it becomes dissolved.

U.S. Pat. No. 4,902,519, issued to Ream et al. on Feb. 20, 1990, shows a candy product wherein molten candy product is poured through the opening of an elastic mold, and then, the opening is sealed with a layer of chewing gum product. Unlike the present invention, Ream's device offers no method of delivering a liquid while one sucks on a lollipop.

U.S. Pat. No. 5,324,527, issued to Coleman on Jun. 28, 1994, describes a lollipop and liquid dispenser. Coleman's device is not capable of being successfully mounted atop a beverage container, and in fact, a reservoir or plastic cylinder is shown in Coleman's device. Furthermore, unlike the present invention, Coleman's device is not capable of being refilled with another lollipop candy when the original lollipop candy has dissolved.

U.S. Pat. No. 5,370,884, issued to Coleman on Dec. 6, 1994, illustrates a lollipop and liquid dispenser. Unlike Coleman's other device, described above, this device is designed to be dipped into a powder container to enhance the flavor of the lollipop. Unlike the present invention, no method or apparatus is shown for delivering liquid into a lollipop. There is no tube or path for liquid to travel into the lollipop. Furthermore, there is no means provided for refitting the entire inedible device with additional lollipop candy should the candy be nearly or completely exhausted.

U.S. Pat. No. 5,462,185, issued to Walker on Oct. 31, 1995, describes a lid for containers. Unlike the present invention, Walker's device does not involve candy at all. Walker' invention does not go beyond the typical beverage container. Walker's invention does not provide a means by which a lollipop can be supplied with liquid directly from a beverage.

U.S. Pat. No. 5,509,551, issued to Terrell on Apr. 23, 1996, shows a beverage container dispensing cap which has no edible part. Unlike the present invention, Terrell's device does not have any means by which liquid can be drawn through candy.

U.S. Pat. No. 2,631,521 issued to Atkins, on Mar. 17, 1953 shows a beverage mixing container. Atkins' invention is unlike the present invention because it relates to a beverage top container with flavored liquid, and encompasses no means for attaching lollipop candy. Atkins' invention is also shaped in a non conical manner, encompasses a needle apparatus for puncturing the top unit to fill up the beverage mixing container, does not have a passageway through the secondary beverage, and does not include exterior candy coating or candy coating of any kind.

U.S. Pat. No. 3,370,737 issued to Harvey, et al., on May 1, 1973 exhibits a coated mouthpiece construction. Harvey's invention is unlike the present invention because it is an attachment for a drinking straw coated with miraculin. Harvey's invention is unlike the present invention because it hinges on the use of miraculin in particular as a coating, is spherical in shape, exhibits no method for replenishing the coating, and cannot attach directly to a beverage container as can the present invention.

U.S. Pat. No. 5,085,330 issued to Paulin, on Feb. 4, 1992 shows a drinking bottle attachment. Paulin's invention is unlike the present invention because it does not include an exterior candy coating, is designed specifically for mixing a carbonated beverage, and ice cream in an interior container, the mixing of the two substances takes place in a separate internal chamber instead of upon the point of consumption, and it is not conical in shape.

U.S. Pat. No. 3,978,233 issued to Bolt on Aug. 31, 1976 shows a liquid warmer. Bolt's invention is unlike the present invention because it is a liquid warmer, has no exterior candy attachment, mixing of the two substances takes place in the upper container, instead of the users mouth, it is not conical in shape, is not an attachment for an existing beverage container, and does not have a singular passageway through the upper member to the outlet as does the present invention.

U.S. Pat. No. 5,085,335 issued to Carbaugh on Feb. 4, 1992 shows a drinking cup apparatus. Carbaugh's invention is unlike the present invention because it has no means for adhering a candy coating, is not an attachment for an existing beverage container, and if used as a beverage mixer, all mixing takes place in the container and not in the user's mouth.

U.S. Pat. No. 3,545,980 issued to Stanger on Dec. 8, 1970 shows a combination straw and flavoring. Stanger's invention is unlike the present invention because it is a straw only and not a secure attachment closure for an existing beverage container. The candy in Stanger's invention is also unlike the present invention, because it is not replacable and is not in a conical shape.

Therefore a need has been established for a novel lollipop beverage top that has replacable candy attachments, and fits securely on existing beverage containers, which allows the user to successfully and satisfyingly combine the flavors of a beverage and a lollipop.

### SUMMARY OF INVENTION

By combining the flavor of a candy-type substance with a beverage, the drinking and flavor experience can be enhanced. More specifically, by drawing a beverage through a dissolvable, edible “lid,” the flavor of the “lid” is intermingled with the beverage. The present invention incorporates both a lollipop handle and such a “lid.”This easily attachable “lid” has an integrated handle thereby providing the consumer with a convenient means of consumption of the lid should the beverage be depleted or the consumer desire the separate and distinct flavor of the two consumables. Given the diversity of beverages currently available, the “lid” or lollipop top, is available in a number of flavors and colors to complement and coordinate the intended beverage.

### BRIEF DESCRIPTION OF DRAWINGS

FIG. 1 is an environmental view of the lollipop top.

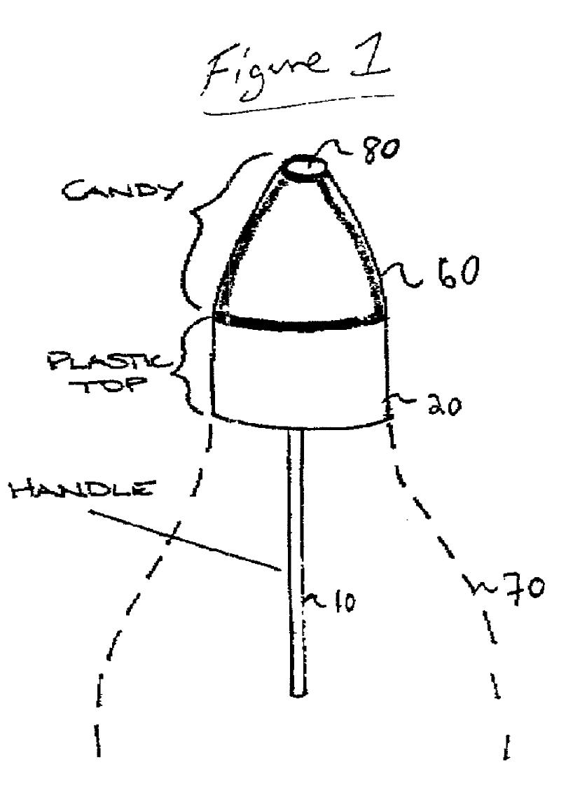

FIG. 2 is a cross sectional view of the lollipop top.

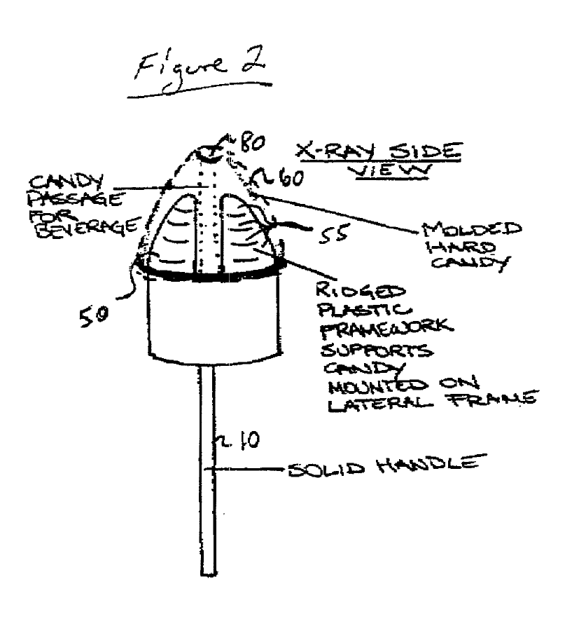

FIG. 3 is a perspective bottom view of the lollipop top

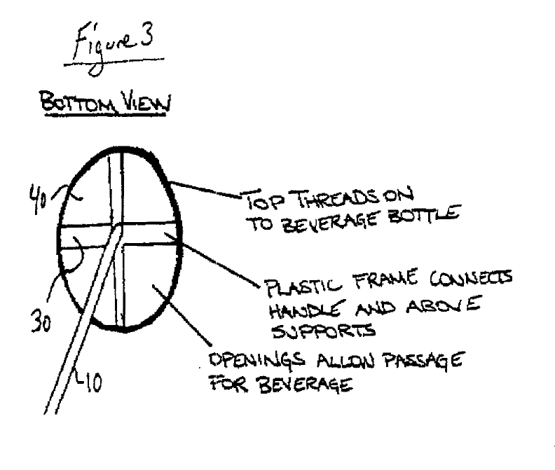

### DETAILED DESCRIPTION

The present invention is a novel apparatus for attachment to a beverage container. Generally, the concept behind the present invention is to permit liquid to travel within the lollipop itself to provide an enhanced eating experience. Should the lollipop become nearly completely dissolved during consumption, a means is provided for the candy's replacement. Alternatively, should a user desire to consume the lollipop without the necessity of a beverage, the present invention has been designed as a fully functional lollipop independent of any beverage container support.

The present invention is constructed from a linear, solid cylindrical handle 10, which is fixedly attached to the center of another larger, internally threaded cylindrical member 20. In another embodiment, the handle 10 can be hollow, to allow the handle 10 to be utilized as a straw. The larger cylindrical member 20 has internal threads (not shown) which frictionally engage the standard beverage dispensing bottle top (not shown). The handle 10, circumscribed by the threaded member 20 at an upper end, intersects the threaded member 20 and is attached thereto via structural members 30 which bisect the threaded member 20. On adjacent sides of the structural members 30 are passageways 40 through which a beverage can flow. It should be noted that the handle 10 is solid, and serves as support for the invention should the user desire to employ the present invention independent of a beverage dispensing top (not shown).

Fixed to the structural members 30 and opposite the side from which the handle 10 protrudes, is a ridged plastic framework 50 to which a consumable 60 (candy or other edible substance) is molded. This framework 50 extends above the threaded member 20 and is bottomless to allow passage of a liquid (not shown). Furthermore, ridged plastic framework 50 has a tiered design with stepped levels 55 to frictionally engage consumable 60. When consumable 60 is completely dissolved during the use of the present invention, replacement consumables 60 may be frictionally refitted to stepped levels 55 so that endless consumption may occur.

The consumable 60 has a hollow core 80 running on the same axis as the handle 10 so that a beverage (not shown), after passing through the threaded member 20 and the framework 50, can exit the container 70 thereby partially dissolving the consumable 60. For variety, the consumable 60 is molded into a and comes in a variety of flavors and colors to complement the attached beverage or can be enjoyed as a stand alone lollipop.

It is to be understood that the present invention is not limited to the embodiments described above, but encompasses any and all embodiments within the scope of the following claims.

1. A lollipop apparatus for use with a container, the container housing a beverage, comprising:
a cylindrical member;
a handle, circumscribed by said cylindrical member;
structural members communicating with said cylindrical member; and
a consumable in communication with said structural members.

2. A lollipop apparatus as in claim 1, wherein said cylindrical member has a threaded member.

3. A lollipop apparatus as in claim 1, wherein said handle is hollow.

4. A lollipop apparatus as in claim 1, wherein said structural members bisect said cylindrical member.

5. A lollipop apparatus as in claim 1, wherein said structural members have ridges.

6. A lollipop apparatus as in claim 1, wherein said consumable has a curved interior.

7. A lollipop apparatus as in claim 6, wherein said curved interior is in communication with said structural members.

8. A lollipop apparatus as in claim 1, wherein said consumable is removably attached.

9. A lollipop apparatus as in claim 1, wherein said structural members are conical in shape.

10. A lollipop apparatus as in claim 1, wherein said consumable is conical in shape.

11. A lollipop apparatus as in claim 3, wherein said handle supports said cylindrical member, said structural members, and said consumable.
